(19) United States
(12) Patent Application Publication
(10) Pub. No.: US 2007/0205875 A1
(43) Pub. Date: Sep. 6, 2007

(54) Auxiliary device with projection display information alert

(76) Inventor: Ido G. De Haan, Assen (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/367,221

(22) Filed: Mar. 3, 2006

(51) Int. Cl. B60Q 1/00

(52) U.S. Cl. 340/425.5; 340/902; 455/41.2

(57) ABSTRACT

An auxiliary device is provided that includes a short-range wireless receiver for receiving information relating to an occurrence of an event involving a portable radio communication equipment for voice and/or information communications. In addition, the auxiliary device includes a projector for projecting a display in response to the receipt of the information relating to the occurrence of the event.

### TECHNICAL FIELD OF THE INVENTION

The present invention relates generally to electronic equipment, and particularly to electronic equipment involving voice and/or information communication.

### DESCRIPTION OF THE RELATED ART

Electronic equipment that provides for voice and/or information communication, such as mobile phones, personal digital assistants, mobile terminals, etc., is becoming increasingly popular. With the wide proliferation of such electronic equipment, users have demanded ways to make the use of such devices less obtrusive in public. Thus, in addition to conventional audible alert functions many such devices are today equipped with a “silent alert” function. Such a silent alert function involves the use of a “non-audible” alerting device built into the equipment. This device typically alerts the user to an incoming call, or possibly other events, with vibrations produced by a mechanism such as a piezoelectric vibrator or a motor with an offset mass. Of course, for such an alerting mechanism to be effective the electronic equipment that contains it must be in physical contact with the user when an alert is provided.

In parallel with the above developments, “Bluetooth” technology has made it practical to connect accessories to electronic equipment via a short-range wireless interface. Bluetooth is a standard for short-range wireless connections between various types of microprocessor-based devices. Bluetooth supports connectivity between computers and peripherals, computers and wireless terminals, and wireless terminals and peripherals, etc., without the use of linking cables. The Bluetooth standard consists of a core specification and supporting documents, including various device profiles that specify signaling required for specific types of devices. A recent core specification is “Specification of the Bluetooth System; Core, version 1.1,” and exemplary profiles are contained in “Specification of the Bluetooth System; Profiles, version 1.1,” both published Feb. 2, 2001 by the Bluetooth special interest group (SIG), Inc., and which are incorporated herein by reference. The Bluetooth SIG is a consortium of companies such as Ericsson, IBM, Intel, Microsoft, Motorola, and others which promulgates Bluetooth standards.

Hands-free headsets have been among the first devices to make use of Bluetooth technology. Such hands-free headsets implement a hands-free Bluetooth profile. Bluetooth connectivity for such headsets means that a headset does not need to be connected via wires to a mobile phone or other Bluetooth-enabled device. Instead, a user of the headset must simply be within about thirty feet of the device. The Bluetooth standards refer to the terminal device as an “audio gateway”. When a terminal in this case wants to alert a user to an incoming call or other event, it plays a ring tone through the ear-piece of the headset. In addition, or in the alternative, the headset may provide a “silent alert” function such as vibration or blinking light. However, if the user does not happen to have the ear-piece inserted or covering his or her ear at the particular time an alert is received then the user may not be aware of the event, since the terminal could be some distance away and possibly enclosed in a briefcase, etc.

Such problems are particularly common in an automobile environment. Frequently a driver uses a Bluetooth headset in conjunction with his or her portable mobile phone to free both hands for driving. Often the automobile audio system, e.g. the radio or cd-player, is playing while the driver is driving the automobile, sometimes at extreme levels depending on driver preferences. Due to a variety of factors, the driver will frequently miss an incoming call as a result of missing the corresponding incoming call alert. For example, even if the driver is wearing the headset the driver may miss an incoming call alert due to the volume of the automobile audio system drowning out an audible alert from the headset or the mobile phone itself.

Even if the headset has a non-audible alert function such as a vibration function, the driver may not detect the vibration originating from the headset. For example, the driver may not have the headset on at the time of the incoming call. Alternatively, the driver may have the headset on but the vibration of an incoming call alert may be overwhelmed by the amount of bass audio reproduction sometimes preferred by drivers. A blinking light type of non-audible alert function will oftentimes be overlooked by the driver as the blinking light is not provided within the line of vision of the driver. As an example, if the driver is wearing the headset the blinking light on the headset cannot be seen. If the headset is placed elsewhere in the automobile, e.g., the passenger seat, within the driver's briefcase, etc., the blinking light either cannot be seen or is well removed from the driver's line of vision. Similarly, any non-audible alert functions provided by the mobile phone itself may go unnoticed by the driver.

In view of the aforementioned shortcomings associated with conventional alert functions, particularly in the automobile environment, there is a strong need in the art for a device that overcomes such shortcomings. More specifically, there is a strong need in the art for a device that provides alerts to a user yet is not subject to being rendered ineffective by an automobile audio system. Furthermore, there is a strong need in the art for a device that can provide non-audible alerts yet remain substantially within the driver's line of vision.

### SUMMARY

According to an aspect of the invention, an auxiliary device is provided that includes a short-range wireless receiver for receiving information relating to an occurrence of an event involving a portable radio communication equipment for voice and/or information communications. In addition, the auxiliary device includes a projector for projecting a display in response to the receipt of the information relating to the occurrence of the event.

According to an aspect, the projector comprises a laser and steering optics for steering a beam from the laser to generate the projected display.

In accordance with another aspect, the short-range wireless receiver comprises a Bluetooth interface.

According to still another aspect, the portable radio communication equipment is a mobile phone.

In accordance with yet another aspect, the event is an incoming call to the mobile phone, and the display indicates the occurrence of the incoming call.

According to another aspect, the display includes information regarding an identity of a caller making the incoming call.

In yet another aspect of the invention, the display includes a graphical image associated with a caller making the incoming call.

According to another aspect, the projector includes a spatial light modulator for forming an image that is projected as the display.

In accordance with another aspect, the portable radio communication equipment includes a positioning system for acquiring position information.

According to still another aspect, the event is the acquiring of the position information and the display represents the position information.

In yet another aspect, the positioning system includes a global positioning satellite (GPS) system.

According to another aspect, the display represents the position information in a form of a map.

In accordance with still another aspect, an automobile system is provided. The system includes a passenger cabin and an auxiliary device. The auxiliary device includes a short-range wireless receiver for receiving information relating to an occurrence of an event involving a portable radio communication equipment for voice and/or information communications. In addition, the auxiliary device includes a projector for projecting a display in response to the receipt of the information relating to the occurrence of the event. The auxiliary device is suitably positioned within the passenger cabin so that the projector will project the display onto a screen surface within the passenger cabin.

According to a particular aspect, the screen surface is a dashboard within the passenger cabin.

According to another particular aspect, the screen surface is formed by a screen fixture mounted on a dashboard within the passenger cabin.

In accordance with still another aspect, the screen surface is the windshield so as to form a head up display.

According to another aspect, the screen surface is a face of a rear view mirror within the passenger cabin.

In yet another aspect, the auxiliary device is mounted to a roof portion of the passenger cabin.

According to still another aspect, the auxiliary device is mounted on a dashboard within the passenger cabin.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a front partial view from within a passenger cabin of an automobile including an auxiliary device for notifying a driver or passenger of an incoming call in accordance with an embodiment of the invention;

FIG. 2 is a side view of the automobile of FIG. 1 shown in partial cutaway in accordance with an embodiment of the present invention;

FIG. 3 is a top view in part of the automobile of FIG. 1 in accordance with an embodiment of the present invention;

FIG. 4 is a schematic view of an auxiliary device in combination with a mobile phone and hands-free headset in accordance with an embodiment of the present invention;

FIG. 5 is a block diagram of a mobile phone suitable for use in accordance with the present invention;

FIG. 6 is a block diagram of the auxiliary device in accordance with an embodiment of the present invention;

FIG. 7A is a schematic block diagram of a projector portion of the auxiliary device in accordance with an embodiment of the present invention;

FIG. 7B is a schematic block diagram of a projector portion of the auxiliary device in accordance with another embodiment of the present invention;

FIG. 8 is a system flowchart suitable for programming the operation of the mobile phone in accordance with an embodiment of the present invention;

FIG. 9 is a system flowchart suitable for programming the operation of the auxiliary device in accordance with an embodiment of the present invention;

FIG. 10 is a perspective view of the auxiliary device mounted to the roof portion of the passenger cabin in accordance with an embodiment of the present invention;

FIG. 11 is a schematic view of an auxiliary device in combination with a mobile phone in accordance with another embodiment of the present invention;

FIG. 12 is a system flowchart suitable for programming the operation of the mobile phone in accordance with another embodiment of the present invention; and

FIG. 13 is a system flowchart suitable for programming the operation of the auxiliary device in accordance with another embodiment of the present invention.

### DETAILED DESCRIPTION OF EMBODIMENTS

The present invention will now be described with reference to the drawings, in which like reference numerals are used to refer to like element throughout.

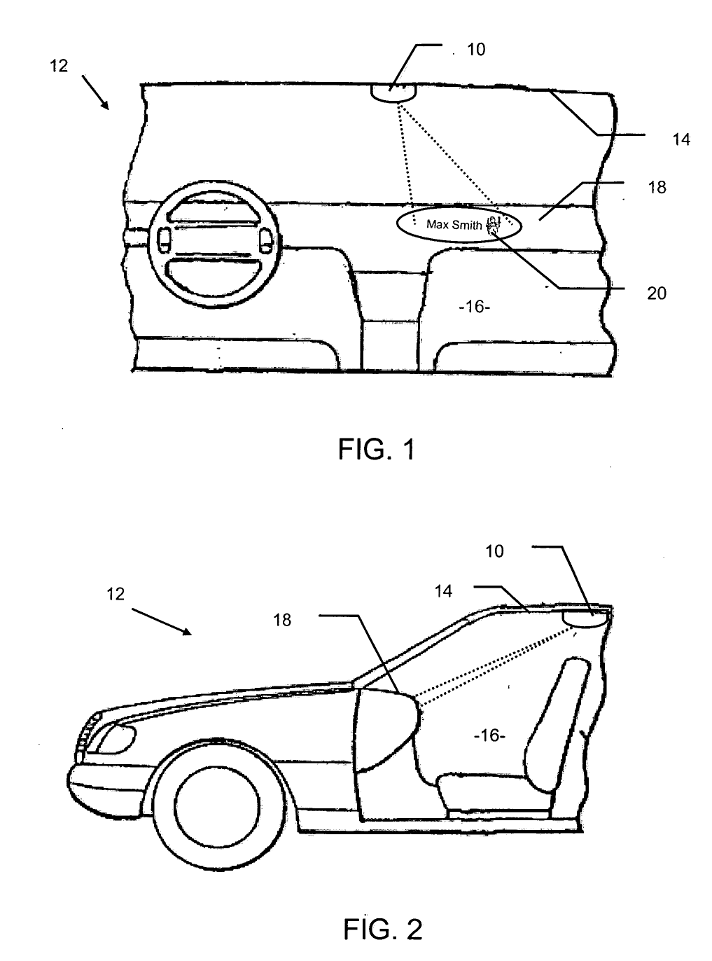

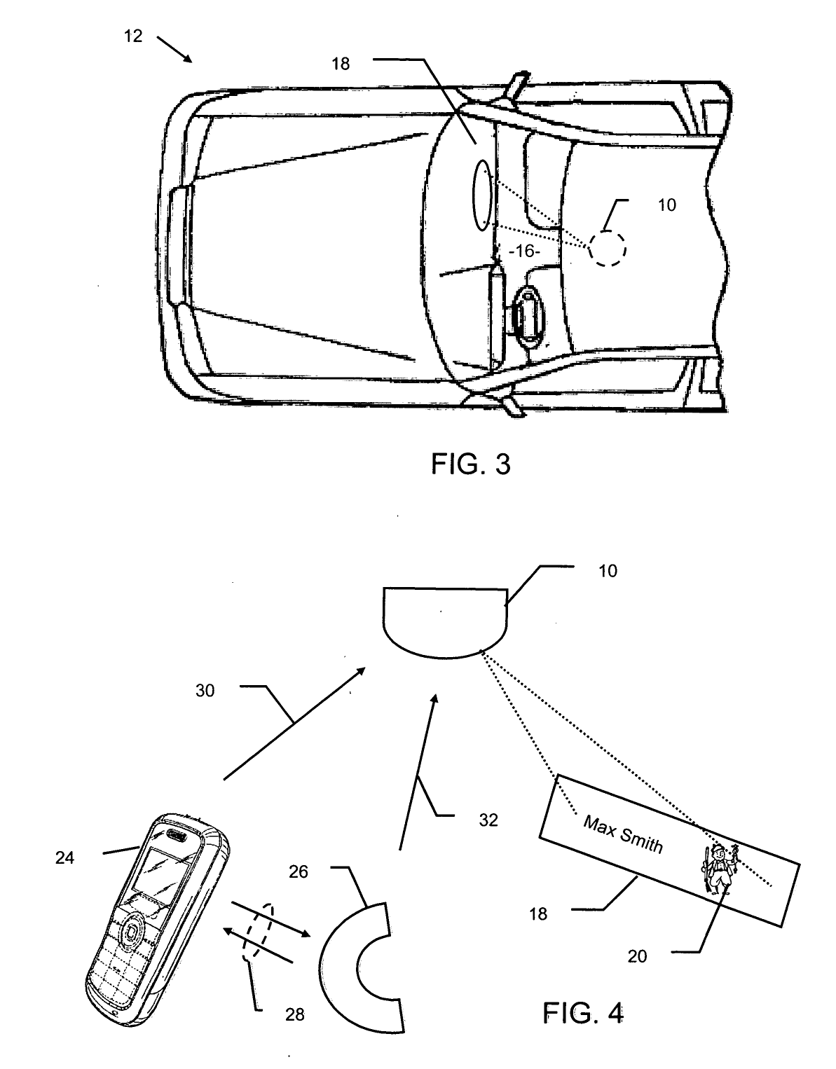

Referring initially to FIGS. 1, 2 and 3, the auxiliary device of the present invention is generally designated 10. The use of the auxiliary device 10 is described herein primarily in the context of its use in an automobile 12. However, those having ordinary skill in the art will appreciate that the auxiliary device 10 has utility in environments other than automobiles. Accordingly, the scope of the invention is not limited to use within an automobile in its broadest sense.

The embodiment of FIGS. 1, 2 and 3 illustrates a configuration in which the auxiliary device 10 is mounted to the roof portion 14 of the passenger cabin 16. As will be explained in more detail below in relation to FIGS. 4 thru 9, the auxiliary device 10 includes a short-range wireless receiver that enables the device 10 to receive incoming call information, caller ID information, etc., from a mobile phone or other portable radio communication equipment. The short-range wireless receiver may utilize any type of transmission medium, including but not limited to a small strength radio signal, infrared or other optical medium, magnetic medium, etc. In the exemplary embodiment, the auxiliary device 10 includes a short-range wireless receiver operating in accordance with the Bluetooth standards. This allows the auxiliary device 10 to receive incoming call information, caller ID information, etc., directly from a Bluetooth enabled mobile phone (e.g., without requiring modifications to the mobile phone or other Bluetooth enabled device).

As will also be explained in more detail below, the auxiliary device 10 further includes a projector for projecting an image onto a screen surface within the passenger cabin 16. More specifically, upon receiving incoming call information from the mobile phone, the auxiliary device 10 utilizes a projector to project information (e.g., alphanumeric and/or graphical images) within the passenger cabin 16 in order to provide the driver and/or passenger with a non-audible alert. For example, FIGS. 1-3 illustrate how the auxiliary device 10 may be set up to project caller ID information such as “Max Smith” onto the dashboard 18 within the passenger cabin 16. In addition, or in the alternative, image information 20 such as a graphical image of “Max Smith” may be projected onto the dashboard 18, for example, to further identify the caller.

In this manner, the auxiliary device 10 of the present invention is able to provide non-audible alerts to a user (e.g., the driver or passenger) in response to an incoming call. The alert is not subject to being rendered ineffective by an automobile audio system due to excessive volume or bass, for example. Furthermore, by projecting the incoming call information onto the dashboard 18, the auxiliary device 10 provides non-audible alerts that remain substantially within the driver's line of vision. Thus, the driver need not be distracted looking for a blinking light, etc. on the mobile phone or headset as in the past.

In the exemplary embodiment, the auxiliary device 10 projects information relating to the receipt of an incoming call directly onto the dashboard 18 of the automobile 12. In another embodiment, however, the automobile 12 may include a dedicated structure with a screen surface and mounted onto the dashboard 18 or elsewhere. In such case, the projector within the auxiliary device 10 is set up to project the information onto the screen surface of the dedicated structure. According to yet another alternative, the auxiliary device 10 may be set up so as to project information onto some other surface within the passenger cabin 16. For example, the projector within the auxiliary device 10 may be positioned so as to project the display onto the front windshield of the automobile 12, thereby forming a type of heads-up-display (HUD). As another example, the projector may be set up or positioned so as to project the display onto the rear view mirror so as to be easily seen by the driver.

In the preferred embodiment, the location of the projected display remains substantially within the driver's line of vision. This avoids any distraction that may cause the driver to take his or her eyes off the road ahead. The particular surface upon which the auxiliary device 10 projects a display is not limited in the broadest sense of the invention.

Similarly, although FIGS. 1-3 illustrate the auxiliary device 10 positioned on the roof of the passenger cabin 16, the auxiliary device 10 may be positioned elsewhere without departing from the scope of the invention. For example, the auxiliary device 10 may be positioned elsewhere in the passenger cabin 16 such on the dashboard itself. Positioning the auxiliary device 10 towards the top portion of the dashboard itself is particularly advantageous as the projector within the auxiliary device can easily be directed to the front windshield and again present a HUD.

Turning to FIG. 4, the primary components used in combination with the auxiliary device 10 are shown in accordance with the exemplary embodiment of the present invention. In the example described herein, the driver (or passenger) riding in the automobile 12 will have with them in the automobile 12 their own personal mobile phone 24 and handsfree headset 26 as shown. As is conventional, the mobile phone 24 and handsfree headset 26 are able to communicate bidirectionally (represented by arrows 28) via Bluetooth connectivity or other short-range wireless connection.

Additionally, the auxiliary device 10 is configured so as to have Bluetooth (or other short-range) connectivity and includes a receiver for receiving information relating to the occurrence of an incoming call from the mobile phone 24. In the exemplary embodiment, the auxiliary device 10 receives the same control communications (represented by arrow 30) typically transmitted to the headset 26 in order to detect the occurrence of an incoming call, receipt of the call, end of call, etc. In this sense, the auxiliary device 10 may simply appear as a pseudo-headset. In addition or in the alternative, the mobile phone 24 may be modified to communicate specifically with the auxiliary device 10 to carry out any non-conventional operations as will be readily appreciated by those having ordinary skill in the art. In yet another embodiment, the auxiliary device 10 and/or headset 26 can be designed to communicate directly with one another as represented be arrow 32. Thus, for example, the mobile phone 24 in receipt of an incoming call can notify the headset 26 and/or the auxiliary device 10 each directly. Alternatively, the mobile phone 24 can be configured to notify the headset 26 which itself is configured to notify the auxiliary device 10. In the preferred embodiment, communications occur directly between the mobile phone 24 and the auxiliary device 10 such that the auxiliary device 10 may be utilized even without the headset 26 if desired.

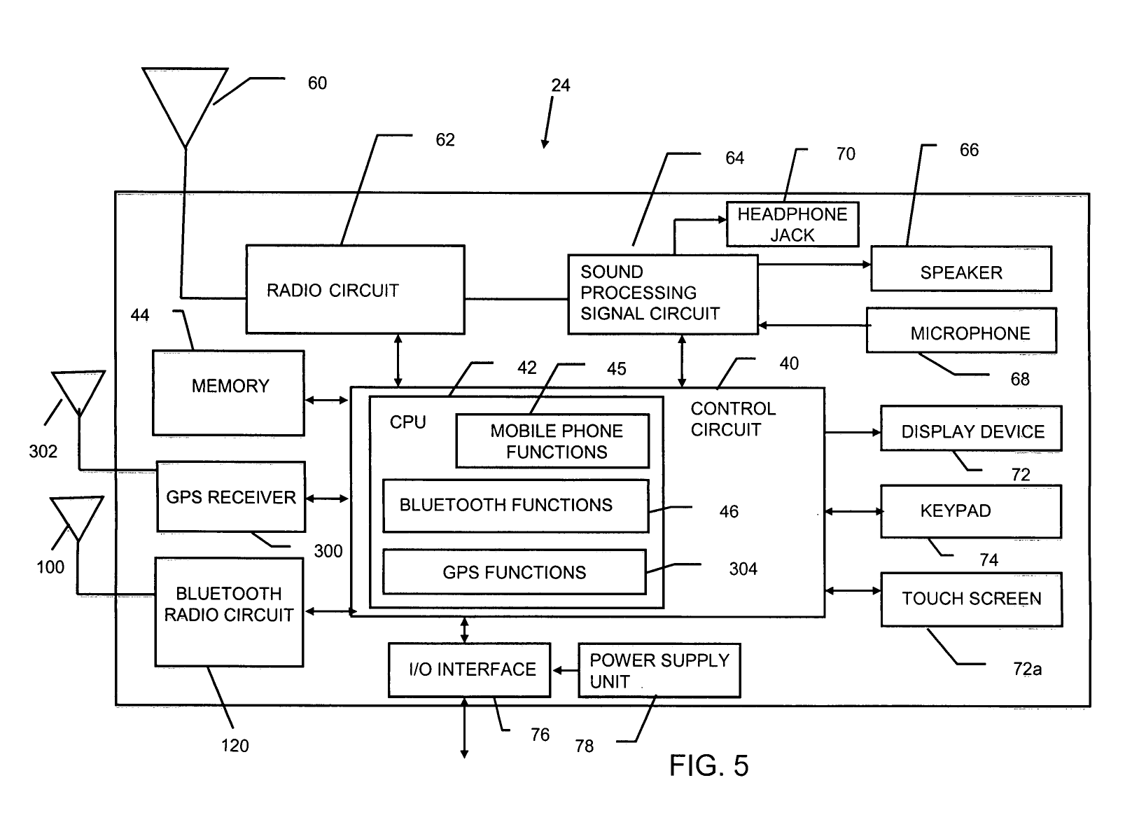

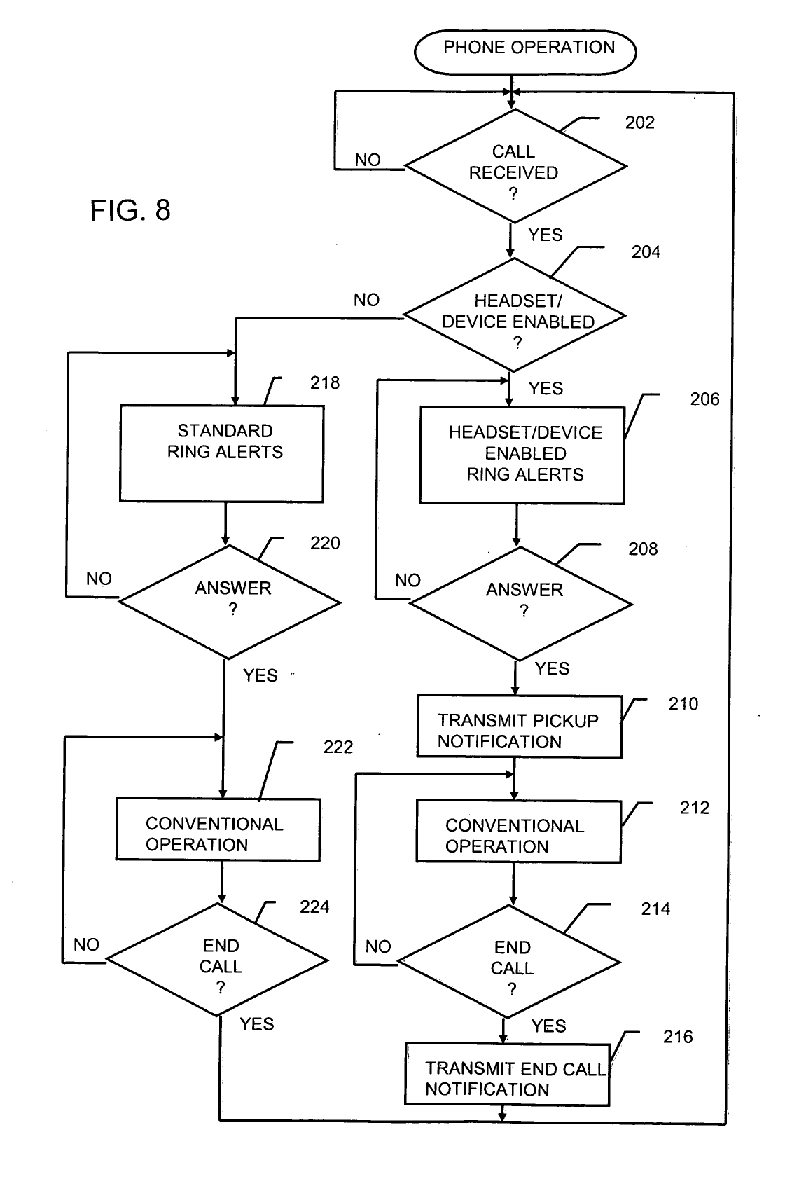

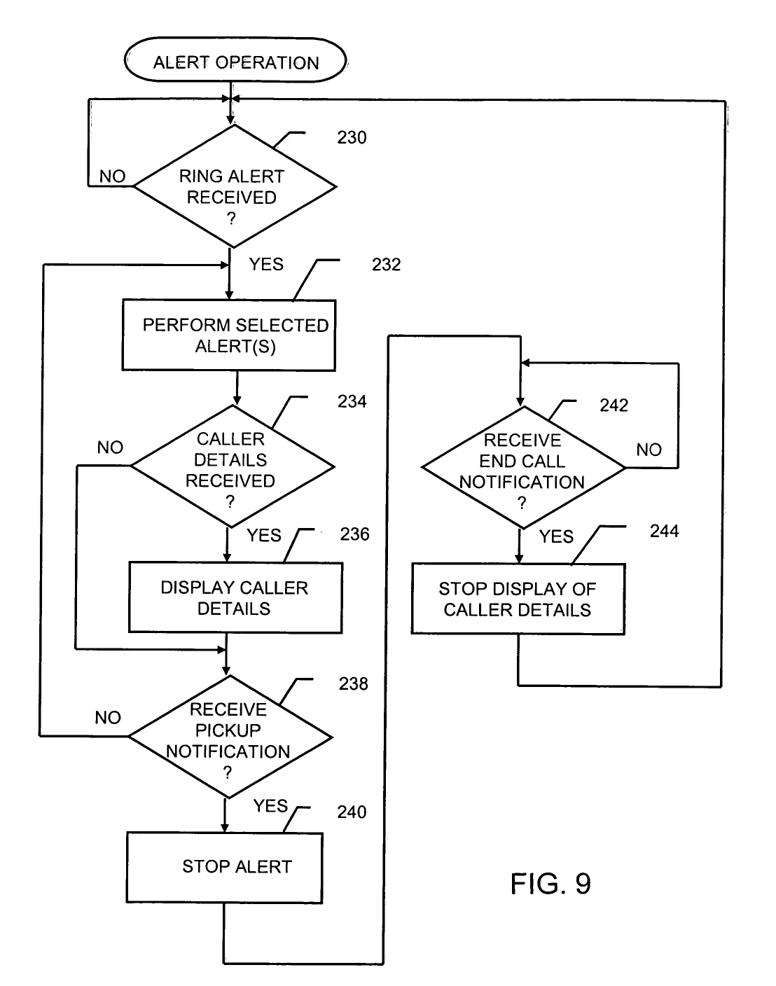

FIG. 5 represents a functional block diagram of the mobile phone 24. The construction of the mobile phone 24 is generally conventional, and therefore is described herein primarily only for completeness. The mobile phone 24 includes a primary control circuit 40 that is configured to carry out overall control of the functions and operations of the mobile phone 10. The control circuit 40 may include a CPU, microcontroller, or microprocessor, etc., collectively referred to herein simply as a CPU 42. The CPU 42 executes code stored in memory (not shown) within the control circuit 40 and/or in a separate memory 44 in order to carry out conventional operation of the mobile phone functions 45 within the mobile phone 24. In addition, however, the CPU 42 executes code stored in the memory 44 in accordance with the present invention in order to perform Bluetooth functions 46 (e.g., connectivity and communications). As is explained in more detail below with respect to FIGS. 8 and 9, the mobile phone 24 performs Bluetooth communications with the headset 26 and/or auxiliary device 10 to provide for hands free operation and non-audible alert functions.

A person having ordinary skill in the art of computer programming and specifically in applications programming for mobile phones and Bluetooth devices will be readily enabled in view of the description provided herein to program a mobile phone 24 and auxiliary device 10 to operate and carry out the functions described herein. Accordingly, details as to the specific programming code have been left out for sake of brevity.

Continuing to refer to FIG. 5, the mobile phone 24 includes an antenna 60 coupled to a radio circuit 62. The radio circuit 62 includes a radio frequency transmitter and receiver for transmitting and receiving signals via the antenna 60 as is conventional. The mobile phone 24 further includes a sound processing circuit 64 for processing the audio signal transmitted by/received from the radio circuit 62. Coupled to the sound processing circuit 64 are a speaker 66, and a microphone 68 which enable a user to listen and speak via the mobile phone 24 as is conventional. In addition, a headphone jack 70 coupled to the sound processing circuit 64 is provided. This allows a wired headset to be connected to the mobile phone 24.

The mobile phone 24 also includes a display 72 and keypad 74 coupled to the control circuit 40. In the case where all or part of the display 72 comprises a touchscreen, such operation may be represented by the touchscreen 72a in FIG. 5. The mobile phone 24 further includes an I/O interface 76. The I/O interface 76 may be in the form of any one of many typical mobile phone I/O interfaces, such as a multi-element connector at the base of the mobile phone 24. As is typical, the I/O interface 76 may be used to couple the mobile phone 24 to a battery charger to charge a power supply unit 78 within the mobile phone 24. Further, the I/O interface 76 may serve to connect the mobile phone 10 to a personal computer or other device via a data cable, etc.

The mobile phone 24 also includes an antenna 80 coupled to a Bluetooth radio circuit 102 for carrying out the above-mentioned Bluetooth functions 46. The Bluetooth radio circuit 102 is coupled to the control circuit 40 and serves to transmit and receive data and information via the Bluetooth standard as will be appreciated. It will be further appreciated that although the mobile phone 24 in FIG. 5 is represented as having separate antennas and radio circuits for the standard RF and Bluetooth functions, portions of the antennas and/or radio circuits may be shared without departing from the scope of the invention.

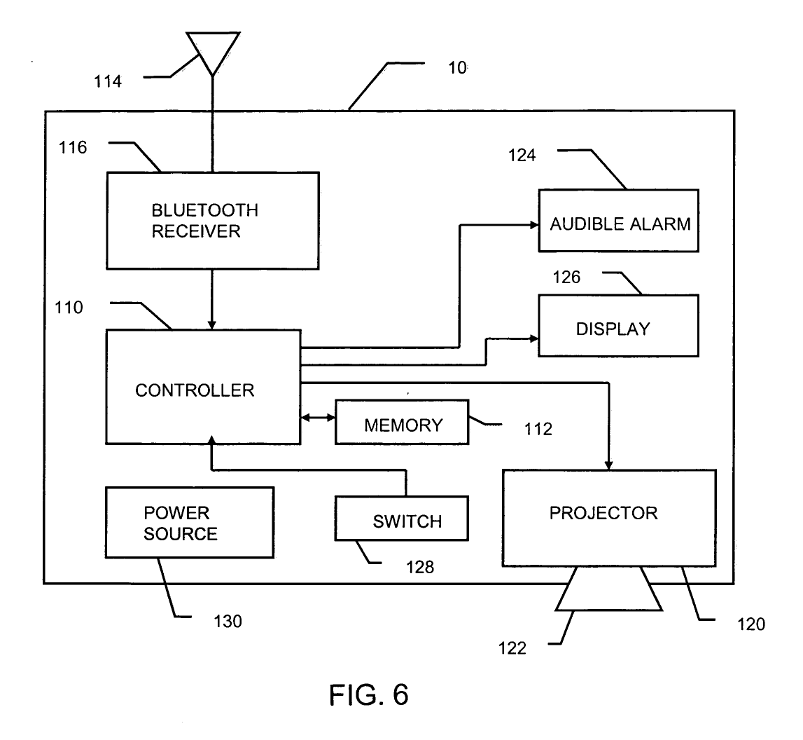

FIG. 6 provides a functional block diagram of the auxiliary device 10 in accordance with the present invention. A controller 110 executing control code stored in a memory 112 is included in the auxiliary device 10 and serves to provide the appropriate control features described herein. The auxiliary device 10 further includes an antenna 114 coupled to a Bluetooth receiver 116. The receiver 116 may include a transmitter function sufficient to establish connectivity, but in the preferred embodiment serves primarily to receive Bluetooth communications from the mobile phone 24. Nevertheless, in an embodiment desiring bidirectional communication between the auxiliary device 10 and the mobile phone 24 and/or headset 26, for example, the receiver 116 can just as easily be replaced by a transceiver, albeit at a slightly higher cost per device 10.

Bluetooth communications received via the antenna 114 and receiver 116 are processed by the controller 110 as described herein and provide the aforementioned incoming call alert via the projected display. More particularly, the auxiliary device 10 further includes a projector 120 driven by the controller 110. Upon receiving an incoming call notification and/or caller information from the mobile phone 24 via the Bluetooth receiver 116, the controller 110 causes the projector 120 to project an incoming call notification (e.g., “Incoming Call”) and/or caller information if provided by the mobile phone 24 (e.g., “Max Smith”). The projector 120 includes a projection lens 122 preferably including a zoom and focus adjustment as is typical with projectors. Thus, when mounting the auxiliary device 10 to the roof of the passenger cabin or elsewhere, the projection lens 122 may be directed towards the desired screen surface and adjusted for size and focus as will be appreciated.

The auxiliary device 10 may further include conventional notification means such as an audible alarm 124 and/or display 126 also driven by the controller 110. A switch 128 may be provided to allow a user to select the particular type(s) of alerts provided by the auxiliary device 10. For example, the auxiliary device 10 may provide an audible or visual alert for an incoming call via the alarm 124 and display 126 in addition to the projected alert via the projector 120. Of course, the audible alert via the alarm 124 and visual alert via the display 126 would suffer from the same types of drawbacks discussed above.

The auxiliary device 10 also includes a power source 130. For example, the power source 130 may be an internal battery source. Alternatively, the power source 130 may be driven from an external source such as the 12V supply voltage within the automobile 12. Preferably, the auxiliary device 10 is a completely self-contained device with its own internal battery source to facilitate simple installation in an automobile 12 as will be appreciated.

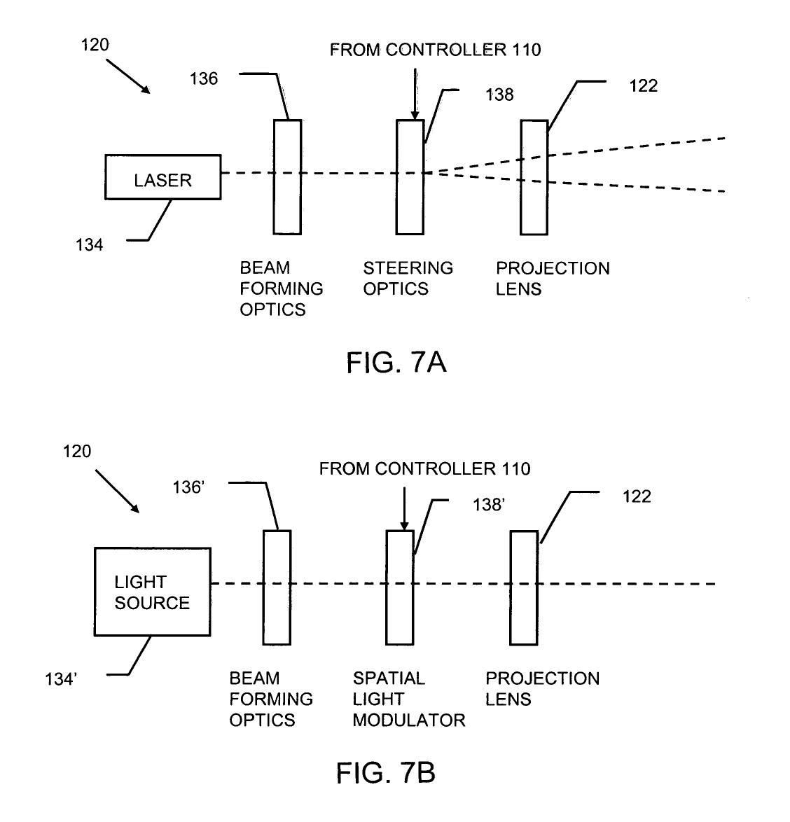

FIGS. 7A and 7B each represent an exemplary embodiment of the projector 120 included in the auxiliary device 10. As will be appreciated, any type of projector 120 may be utilized in the auxiliary device 10 without departing from the scope of the present invention in its broadest sense. In accordance with the embodiment of FIG. 7A, the projector 120 is a conventional laser-based projector. The projector 120 includes a laser source 134 such as a laser diode. Beam forming optics 136 serve to shape the laser beam output from the laser source 134 as appropriate. Steering optics 138 function to steer the laser beam in order to form the desired image representing a call alert, caller information, etc., using conventional laser projector techniques. For example, the steering optics 138 may include a gimble-mounted mirror or micro-mirror on a substrate which is controlled in such a manner to cause the laser beam to scan in X and Y directions in order to produce an image. The controller 110 (FIG. 6) drives the steering optics 138 based on the desired information/images to be displayed. The laser beam is then projected through the projection lens 122 onto the dashboard 18 (FIG. 1) or other projector screen surface.

FIG. 7B represents an embodiment using a conventional spatial light modulator (SLM) based projector 120. The light source 134′ in this embodiment is typically a bright light source such as a high intensity bulb, high intensity light emitting diode(s) (LED(s)), etc. The beam forming optics 136′ serve to uniformize the output intensity of the light source 134′ so as to uniformly illuminate an SLM 138′. Using conventional techniques, the controller 110 (FIG. 6) drives the individual pixels in the SLM 138′ in order to create an image of the call alert, caller information, etc. The image formed by the SLM 138′ is then projected via the projection lens 122 onto the dashboard 18 or other screen surface.

The SLM 138′ may be formed of any type device such as a liquid crystal display (LCD) device, digital light processing (DLP) device, liquid crystal on silicon (LCOS) device, etc., without departing from the scope of the invention. Although the SLM 138′ is represented as a transmissive type device in FIG. 7B, it will be appreciated that the SLM 138′ could alternatively be a reflective type device.

FIG. 8 is a flowchart representing the general operation of the mobile phone 24 in accordance with its use with the present invention. The mobile phone 24 will typically be on the person and/or within the passenger cabin 16 of the driver or passenger riding in the automobile 12. The mobile phone 24 is programmed to connect with the headset 26, if utilized, and/or the auxiliary device 10 using known connectivity protocols of Bluetooth or the particular short-range wireless technology shared between the devices.

Once such connectivity has been established, the mobile phone 24 determines in step 202 whether an incoming call has been received via the conventional mobile phone network service provider. If no, the mobile phone 24 continues to loop around step 202. In the event a call is received as determined in step 202, the mobile phone 24 proceeds to step 204 in which it determines whether the user has selected that the headset 26 and/or auxiliary device 10 be enabled. In one embodiment of the invention, the auxiliary device 10 is designed simply to emulate the headset 26. Thus, the control and information communications that the mobile phone 24 sends to the headset 26 are also received by the auxiliary device 10. Accordingly, in the same manner a conventional mobile phone 24 is designed nowadays to transmit incoming call notifications, caller ID information, etc., to a conventional headset 26 and a display therein, the auxiliary device 10 may receive such information in accordance with the invention. This avoids the need to specially program the mobile phone 24 to connect to the auxiliary device 10. On the other hand, it will be readily apparent to those having ordinary skill in the art that the mobile phone 24 can be programmed to connect specifically to the auxiliary device 10 even in the absence of a headset 26. The present invention contemplates any and all such embodiments.

In step 204, if the headset 26 and/or auxiliary device 10 is enabled the mobile phone 24 proceeds to step 206. The mobile phone 24 in step 206 transmits an incoming call notification, or “ring alert”, to the headset 26 and/or the auxiliary device 10. As will be described in more detail with respect to FIG. 9, the auxiliary device 10 responds to the receipt of the ring alert by performing the selected alert. For example, the auxiliary device 10 causes the notification “Incoming Call” to be projected onto the dashboard 18 so that it may be seen by the driver and/or passenger regardless of whether the driver and/or passenger is wearing his/her headset 26, is listening to music at high volumes, is unable to see the headset 26 and/or mobile phone 24 easily, etc. In the event caller ID information, associated graphics, etc., are available, the mobile phone 24 also transmits such additional information to the auxiliary device 10 in step 206 so that it may also be displayed on the dashboard 18 or other screen surface.

Following step 206, the mobile phone 24 determines in step 208 whether the call has been answered. Such detection may be based on the user answering the mobile phone 24 itself, or “picking up” via the pressing of a corresponding button, etc., on the headset 26, as is conventional. Alternatively, speaker phone capabilities may be built into the auxiliary device 10 such that the user may answer and conduct a telephone call via the auxiliary device 10, again using conventional technology except that the auxiliary device 10 is performing the hands free function of the headset 26.

If the incoming call is not answered as determined in step 208, the mobile phone 24 continues to loop around step 206 and the auxiliary device 10 continues to display the incoming call information. If the incoming call is answered as determined in step 208, the mobile phone 24 in step 210 transmits a pickup notification to the headset 26 and/or auxiliary device 10. Again as explained in more detail below with respect to FIG. 9, this may cause the auxiliary device 10 to change it's projected display from “Incoming Call” or the like, to “Call Duration X:XX” or the like together with the caller details as is conventional with mobile phones and headsets, for example.

In step 212, the mobile phone 24 operates in a conventional manner as the call is conducted. Next, in step 214 the mobile phone 24 determines if the call has ended. The end of a call may be detected via conventional techniques, including the pressing of a “hang up” button by the user on the mobile phone 24 or headset 26. Alternatively, in an embodiment in which the auxiliary device 10 includes speaker phone capabilities, the user may hand up via pressing an appropriate button, etc., on the auxiliary device 10 as will be appreciated.

If the call has ended as determined in step 214, the mobile phone 24 transmits and end call notification to the headset 26 and/or auxiliary device 10 in step 216. This prompts the auxiliary device 10 to end the display of the caller details, etc., and perhaps briefly display a “Call Ended” notification along with time duration, etc. If in step 214 the end of the call has not been detected, the mobile phone 24 continues to loop thru steps 212 and 214 as shown.

In the event the headset 26 and or auxiliary device 10 has not been enabled as determined in step 204, the mobile phone 24 simply proceeds with conventional call operation. Specifically, standard ring alerts are issued within the mobile phone 24 as represented in step 218. If the phone 24 is answered as represented in step 220, conventional operation is continued during the call as represented in step 222. Otherwise, the standard ring alerts continue via step 218. Following step 222, the mobile phone 24 determines if the call has ended as represented by step 224. If not, the mobile phone 24 continues to loop thru step 222 as shown.

Following the end of a call as represented in either step 216 or step 224, the mobile phone 24 returns to step 202 as represented in FIG. 8.

FIG. 9 represents the operation of the auxiliary device 10 as carried out by the controller 110. Beginning in step 230, the controller 110 determines whether a ring alert has been received from the mobile phone 24 via the Bluetooth (or other short-range wireless) receiver 116 as described above in relation to step 206. If no, the controller 110 continues to loop thru step 230. Upon receiving such a ring alert in step 230, the controller 110 causes the auxiliary device 10 to perform the desired ring alerts. As previously described, the auxiliary device 10 may include a switch 128 that enables the user to select the desired types of alerts, which may include an audible alert, a standard display, and the projected display via the projector 120. Assuming the user has selected a display via the projector 120, the controller 110 in step 232 causes the projector 120 to display the “Incoming Call” alert or the like via control/data provided to the steering optics 138 in the case of a laser projector 120, or to the SLM 138′ in the case of an SLM-based projector 120.

Next, in step 234 the controller 110 determines if a caller ID or other caller information (e.g., including images) has been received from the mobile phone 24 via the receiver 116, again as described above in relation to step 206. If yes, the controller 110 causes the projector 120 to display such information as represented in step 236. If no additional caller details are provided by the mobile phone 24 as determined in step 234, for example as a result of a caller ID being blocked by the caller, the controller 110 skips step 236 and proceeds to step 238. In step 238, the controller 110 determines if a pickup notification has been received from the mobile phone 24 via the receiver 116 as described above in relation to step 210. If no in step 238, the controller 110 continues to loop through steps 232-236 resulting in the projector 120 continuing to display the incoming call alert. If a pickup notification is received from the mobile phone 24 as determined in step 238, the controller 110 proceeds to step 240 in which the controller 110 causes the projector 120 to stop displaying the incoming call alert (e.g., “Incoming Call”). Based on the preferences of the user, however, the auxiliary device 10 may be configured such that the projector 120 continues to display the additional details relating to the caller, e.g., caller ID, name, image, etc., on the dashboard 18.

Following step 240, the controller 110 in step 242 determines whether an end call notification has been received via the receiver 116 in relation to step 216 discussed above. If not, the auxiliary device 10 continues to loop thru step 242. If an end call notification has been received, the controller 110 proceeds to step 244 in which it causes the projector 120 to cease display of the caller details as discussed above.

Accordingly, it will be appreciated that the auxiliary device 10 in accordance with the present invention provides alerts to a user yet is not subject to being rendered ineffective by an automobile audio system. Moreover, the auxiliary device 10 is capable of providing non-audible alerts which remain substantially within the driver's line of vision.

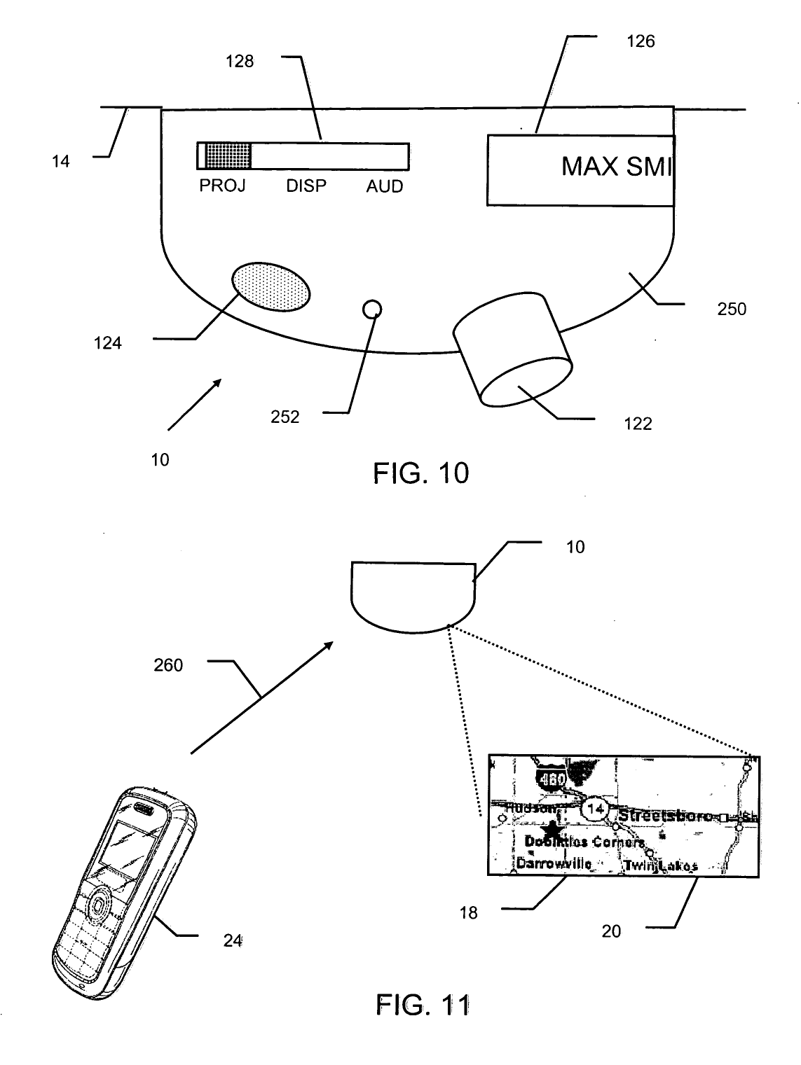

FIG. 10 illustrates an exemplary physical embodiment of the auxiliary device 10 in accordance with the invention. As shown, the auxiliary device 10 includes a dome like housing 250. The housing 250 may be mounted to the interior roof portion 14 of the passenger cabin 16 via Velcro® or some other conventional means. As illustrated, the auxiliary device 10 includes the projector lens extending from the housing to facilitate focusing, etc., via the rotation of outer focusing rings or the like. Moreover, the auxiliary device 10 includes the switch 128 for selecting the type of notification the user would prefer to receive, and a standard display 126. A speaker 124 is included to provide an audible alarm. In addition, the speaker 124 together with a microphone 252 may serve as part of a speaker phone functionality of the auxiliary device 10 as discussed above. Although the switch 128 as shown in FIG. 10 includes discrete positions for a projected alert, visual alert and audible alert, respectively, it will be appreciated that the switch 128 may further include positions selecting any combination thereof.

Referring now to FIG. 11, another embodiment of the invention is shown. In particular, the present invention also has utility in the context of displaying position information such as location, navigation data, maps, etc. Currently, various types of portable radio communication equipment such as mobile phones have a global positioning satellite (GPS) receiver and/or other type positioning information receiver either built into the mobile phone itself or as part of a positioning system module to which the mobile phone may be connected. The positioning information may include location coordinates obtained from a series of satellites or otherwise, alone or in combination with other geographical information which may also be received via satellite or otherwise, such as by being stored locally or acquired online from an online database via a general packet radio service (GPRS), 3G connection, etc. However, the screen on the mobile phone or other portable radio communication equipment itself is quite limited insofar as being able to display the position information in an appreciable way. Currently, a separately mounted navigation display is necessary.

FIG. 11 represents a portable radio communication equipment such as a mobile phone 24 that, in this embodiment, transmits position information (represented by arrow 260) to the auxiliary device 10. The phone 24 transmits the position information to the auxiliary device 10 preferably again using the short-range wireless received used above in connection with the embodiment of FIG. 4. For example, the mobile phone 24 transmits the position information to the auxiliary device 10 using the Bluetooth radio circuit 120 (FIG. 5) of the mobile phone 24 and the Bluetooth receiver 116 (FIG. 6) of the auxiliary device 10. The controller 110 in the auxiliary device 10 is programmed so as to cause the projector 120 to project the display of the position information onto the dashboard 18 or other screen surface. For example, the projector 120 projects an image 20 such as a map with navigation information such as location and directions. The projector 120 updates the display when new position information is provided by the mobile phone 24. In this manner, a separate navigation display, typically a relatively expensive LCD type display is not necessary as the position information obtained by the mobile phone 24 is displayed inexpensively on the dashboard 18 or other simple screen surface. Moreover, the information is displayed in the general line of sight of the driver and preferably having an image size which is substantially larger than a mobile phone 24 or the like, resulting in a much more informative and easy to read image.

Referring briefly to FIG. 5, the mobile phone 24 according to the present embodiment may include a GPS receiver 300 and corresponding antenna 302, for example. The GPS receiver 300 and antenna 302 function as found in conventional mobile phones 24 in order to obtain location information via the GPS satellite system as is known. The CPU 42 in the mobile phone 24 executes code stored in the memory 44 in known fashion to carry out conventional operation of the GPS functions 304 based on the GPS data received via the GPS receiver 300 and any other position information such as geographical information stored locally in memory 44, obtained via GPRS and the radio circuit 62, etc. Unlike conventional mobile phones, however, the mobile phone 24 is programmed to transmit the position information to the auxiliary device 10 via the Bluetooth radio circuit or other short-range wireless transmitter.

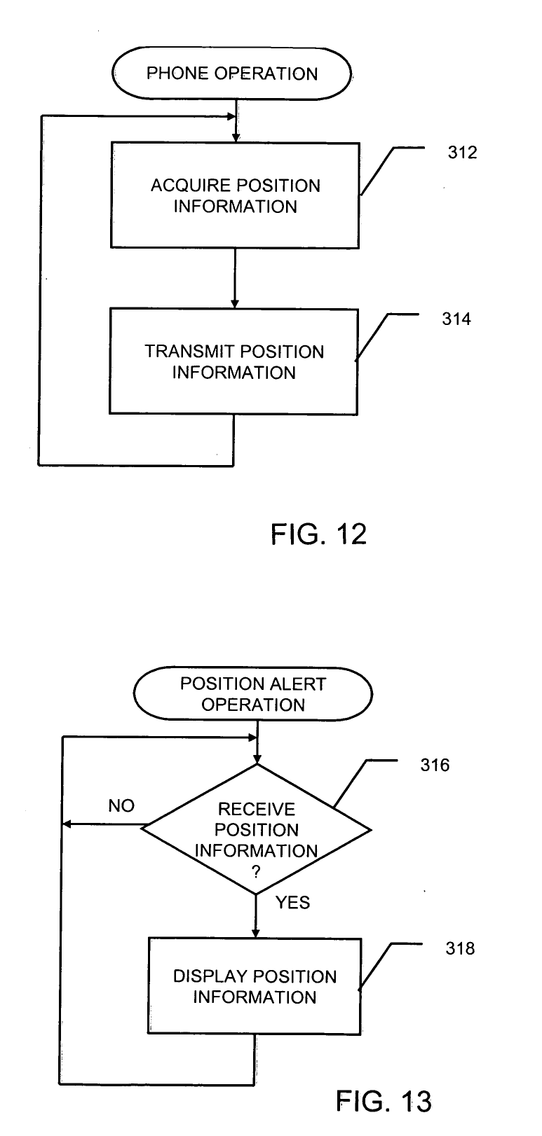

FIG. 12 represents the operation of the mobile phone 24 in carrying out the display of position information in accordance with the present embodiment. Step 312 represents each time the mobile phone 24 acquires new or updated position information as described above. Following step 312, the mobile phone 24 in step 314 transmits the new or updated position information to the auxiliary device 10 as also described above. Following step 314, step 312 is repeated as shown.

FIG. 13 represents the operation of the auxiliary device 10. In step 316, the controller 110 of the auxiliary device 10 determines if position information has been received from the mobile phone 24 via the Bluetooth receiver 116 as a result of step 314. If not, the auxiliary device 10 continues to loop thru step 316 as represented in FIG. 13. When position information is received as determined in step 316, the auxiliary device 10 proceeds to step 318 in which the controller 110 provides image data representing the position information to the projector 120 as is discussed above.

Those having ordinary skill in the art will appreciate that the term “electronic equipment” as referred to herein includes portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. For example, the information provided from the auxiliary device 10 need not be an incoming call alert or position information alert from a mobile phone. Rather, the information may relate to another type of information and/or some other piece of electronic equipment capable of transmitting information to the auxiliary device 10 via short-range wireless communication. As a specific example, the information may be a text message received by the mobile phone 24. The mobile phone 24 is configured to transmit the text message to the auxiliary device 10 that in turn is configured to present the text message to the driver and/or passenger on the dashboard 18 via the projector 120. Alternatively, another type of electronic equipment such as a PDA may be configured to transmit schedule reminders to the auxiliary device 10 via short-range wireless communication (e.g., Bluetooth), so that the reminder is displayed on the dashboard for the benefit of the driver and/or passenger. In this manner, the driver and/or passenger need not be looking directly at his or her PDA.

The present invention includes all such equivalents and modifications, and is limited only by the scope of the following claims.

1. An auxiliary device, comprising:
a short-range wireless receiver for receiving information relating to an occurrence of an event involving a portable radio communication equipment for voice and/or information communications; and
a projector for projecting a display in response to the receipt of the information relating to the occurrence of the event.

2. The auxiliary device of claim 1, wherein the projector comprises a laser and steering optics for steering a beam from the laser to generate the projected display.

3. The auxiliary device of claim 1, wherein the short-range wireless receiver comprises a Bluetooth interface.

4. The auxiliary device of claim 1, wherein the portable radio communication equipment is a mobile phone.

5. The auxiliary device of claim 4, wherein the event is an incoming call to the mobile phone, and the display indicates the occurrence of the incoming call.

6. The auxiliary device of claim 4, wherein the display includes information regarding an identity of a caller making the incoming call.

7. The auxiliary device of claim 4, wherein the display includes a graphical image associated with a caller making the incoming call.

8. The auxiliary device of claim 4, wherein the projector comprises a laser and steering optics for steering a beam from the laser to generate the projected display.

9. The auxiliary device of claim 4, wherein the projector comprises a spatial light modulator for forming an image that is projected as the display.

10. The auxiliary device of claim 4, wherein the short-range wireless receiver comprises a Bluetooth interface.

11. The auxiliary device of claim 1, wherein the portable radio communication equipment comprises a positioning system for acquiring position information.

12. The auxiliary device of claim 11, wherein the event is the acquiring of the position information and the display represents the position information.

13. The auxiliary device of claim 12, wherein the positioning system comprises a global positioning satellite (GPS) system.

14. The auxiliary device of claim 12, wherein the display represents the position information in a form of a map.

15. An automobile system, comprising:
a passenger cabin; and
an auxiliary device, comprising:
a short-range wireless receiver for receiving information relating to an occurrence of an event involving a portable radio commununication equipment for voice and/or information communications; and
a projector for projecting a display in response to the receipt of the information relating to the occurrence of the event,
wherein the auxiliary device is suitably positioned within the passenger cabin so that the projector will project the display onto a screen surface within the passenger cabin.

16. The automobile system of claim 15, wherein the screen surface is a dashboard within the passenger cabin.

17. The automobile system of claim 15, wherein the screen surface is formed by a screen fixture mounted on a dashboard within the passenger cabin.

18. The automobile system of claim 15, wherein the screen surface is the windshield so as to form a head up display.

19. The automobile system of claim 15, wherein the screen surface is a face of a rear view mirror within the passenger cabin.

20. The automobile system of claim 15, wherein the auxiliary device is mounted to a roof portion of the passenger cabin.

21. The automobile system of claim 15, wherein the auxiliary device is mounted on a dashboard within the passenger cabin.

22. The automobile system of claim 15, wherein the projector comprises a laser and steering optics for steering a beam from the laser to generate the projected display.

23. The automobile system of claim 15, wherein the projector comprises a spatial light modulator for forming an image that is projected as the display.

24. The automobile system of claim 15, wherein the short-range wireless receiver comprises a Bluetooth interface.

25. The automobile system of claim 15, wherein the portable radio communication equipment comprises a positioning system for acquiring position information.

26. The automobile system of claim 25, wherein the event is the acquiring of the position information and the display represents the position information.

27. The automobile system of claim 26, wherein the positioning system comprises a global positioning satellite (GPS) system.

28. The automobile system of claim 26, wherein the display represents the position information in a form of a map.
